(19) United States
(12) Patent Application Publication
(10) Pub. No.: US 2010/0044225 A1
(43) Pub. Date: Feb. 25, 2010

(54) NANO-STRUCTURE WITH CAPS

(76) Inventors: Yong Hyup Kim, Seoul (KR); Tae June Kang, Seoul (KR)

Correspondence Address: Yong Hyup Kim, Acrovista C-505, 1685-3 Seocho-dong, Seocho-gu, Seoul, 137-921, KR

(21) Appl. No.: 12/197,765

(22) Filed: Aug. 25, 2008

(51) Int. Cl. G01N 27/30; D01F 9/12; B32B 1/08; B32B 37/02; B23K 31/02

(52) U.S. Cl. 204/403.15; 423/447.2; 423/447.1; 428/402; 228/101; 219/162; 156/247; 977/743

(57) ABSTRACT

A nano-structure is provided. In some embodiments, the nano-structure includes a carbon nanotube with a carbon nanotube body. The carbon nanotube body has at least one cap at one end of the nanotube body. Also provided are methods of making the nano-structures described herein.

### TECHNICAL FIELD

The present disclosure relates generally to the field of nano-science.

### BACKGROUND

Recently, the field of nano-structures has attracted great attention in many research fields due to their unique properties. The placement and orientation of nano-structures is an area of nano-science that has generated great interest and research in this field.

### SUMMARY

Embodiments of carbon nanotubes, apparatuses including carbon nanotubes, methods of assembling carbon nanotubes and an electrode, and methods of manufacturing carbon nanotubes are disclosed herein. In one embodiment, a nano-structure includes a nanotube having first and second ends and a first nano-cap positioned at the first end of the nanotube.

In another embodiment, a method of coupling a nanotube and an electrode includes positioning the nanotube having at least one metal cap with an electrode and coupling the at least one metal cap with the electrode.

In yet another embodiment, an apparatus includes a first electrode and a nanotube having a first cap coupled with the first electrode.

In still yet another embodiment, a method of creating a nano-structure includes growing a nanotube on a substrate, insulating the nanotube with an insulating material, removing a first side of the insulating material exposing a first portion of the nanotube, adding a cap on the first portion of the nanotube and removing the substrate from the nanotube.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A and 1B show schematics of some illustrative embodiments of carbon nanotubes having metal caps.

FIGS. 2A to 2C show illustrative embodiments of methods of assembling carbon nanotubes and electrodes, as well as some illustrative examples of fabricated devices.

FIGS. 3A to 3H show illustrative embodiments of methods of manufacturing carbon nanotubes.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described and illustrated in the Figures herein, could be arranged and designed in a wide variety of different configurations.

A number of devices, such as field effect transistors, bio/chemical sensors and memory devices, may be fabricated based on nano-structures, such as single-walled carbon nanotubes (SWNTs). In these devices, the placement and orientation of the nano-structure components may be controlled within the range of micrometers to nanometers in order to properly integrate the nano-structure components in the devices.

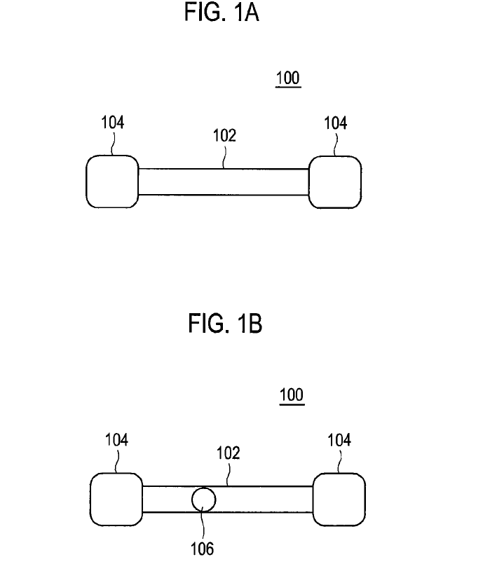

In one aspect, the present disclosure provides methods of assembling nano-structures such as carbon nanotubes and electrodes where the carbon nanotubes include one or more caps. In some embodiments, the caps are metal caps. Referring to FIG. 1A, one embodiment of a nano-structure 100 having a nano-body 102 with caps 104 is illustrated. For example, a representative nano-structure of FIG. 1A can be a nanotube such as a carbon nanotube (CNT) having metal caps. In the illustrative embodiment, the carbon nanotube 100 includes a carbon nanotube body 102 and metal caps 104. Although FIG. 1A shows the carbon nanotube body 102 in an elongated rod shape, it should be recognized that this is for purposes of illustration and the present disclosure is not limited thereto. For instance, the carbon nanotube body 102 may have other appropriate shapes such as, but not limited to, a tapered shape, a bamboo shape, a comb shape, a fish-bone shape and the like. Further, it should be appreciated that although two caps 104 are coupled with one carbon nanotube body 102 to constitute a dumbbell-shaped carbon nanotube 100 in FIG. 1A, the number of caps 104 is not necessarily limited to two and any other number of caps 104 may be incorporated for one unit of carbon nanotube 100. In some embodiments, the number of caps may be 1, 2, 3, 4, 5, 6, 7, 8, 9, 10 or more. In addition, in some embodiments, a rod-shaped carbon nanotube body 102 may be coupled with one cap 104 at one of its terminals (i.e., no cap is provided at the other terminal) without departing from the scope of the claimed subject matter.

The caps 104 may allow the carbon nanotube 100 to be easily aligned and guided by electromagnetic fields. Further, due to the caps 104, electrical contact between the carbon nanotube 100 and an electrode may be easily made, for example, by an annealing process or electron-gun irradiation. In one embodiment, the caps 104 may be fabricated from magnetic metals, such as nickel (Ni), iron (Fe), cobalt (Co) and the like. Further, noble metals, such as gold (Au), platinum (Pt), palladium (Pd) and the like, may be utilized as materials for the caps 104. However, it should be expressly recognized herein that the material of the caps 104 is not necessarily limited to the above-mentioned materials. That is, the caps 104 may be made of other suitable metals as well as chemical compounds or mixtures including the metals (e.g. metal alloys). Alternatively, the caps 104 may be made of non-metallic materials which can be affected by electromagnetic fields such as carbon nano-structures, ceramics, rare earth materials and the like.

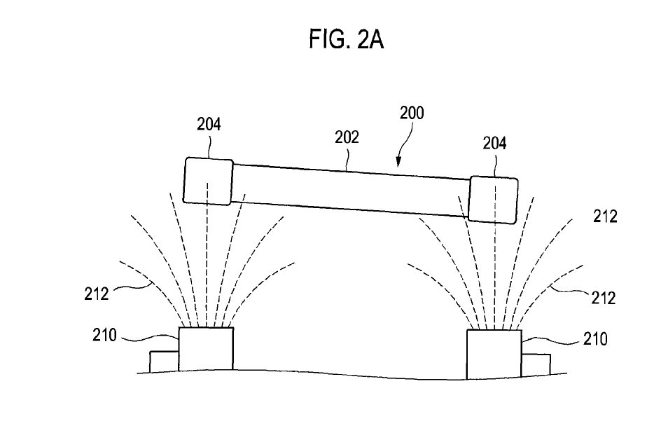

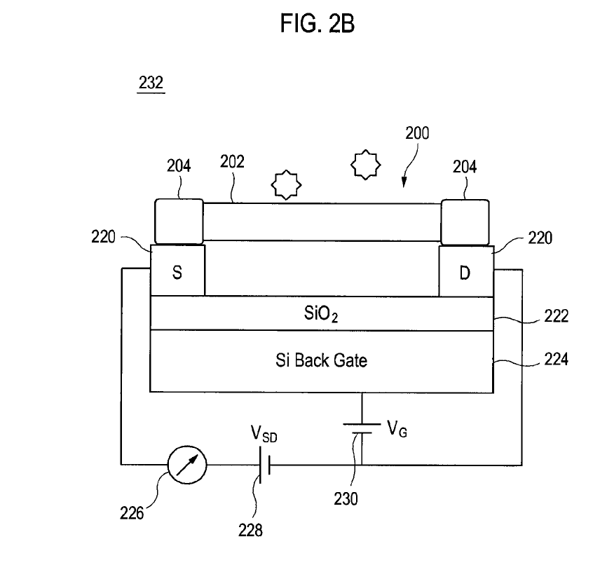

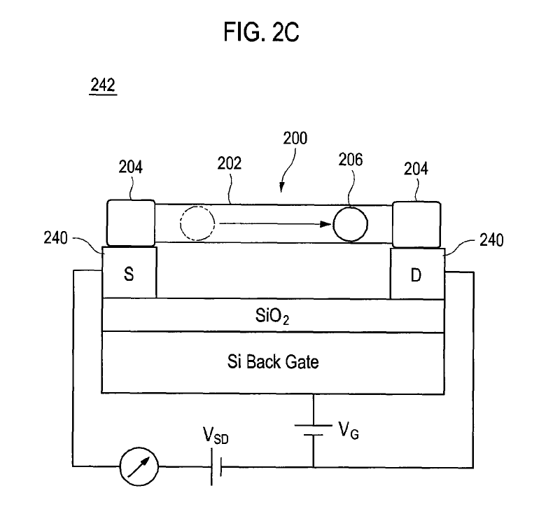

With reference to FIG. 1B, the carbon nanotube 100 may further incorporate one or more nanoparticles 106 in the carbon nanotube body 102. The nanoparticles 106 may include, for example, fullerenes such as C60 and/or metal nanoparticles. However, it should be appreciated that the nanoparticles are certainly not limited thereto. As will be described below with reference to FIG. 2C, the incorporation of nanoparticles 106 may be helpful in the application of the carbon nanotube 100 in electronic devices such as, for example, a memory device.

In one aspect, the disclosure describes methods of assembling nano-structures such as carbon nanotubes and electrodes. In an illustrative embodiment, methods for assembling a carbon nanotube 200, which includes a carbon nanotube body 202 and metal caps 204 (FIG. 2A), is shown. First, the carbon nanotube 200 may be positioned so that its metal caps 204 can contact electrodes 210. The metal caps 204 may then be permanently coupled with the electrodes 210 by, for example, welding or other applicable coupling schemes, thereby fixedly assembling the carbon nanotube 200 on the electrodes 210. According to one embodiment, the electrodes 210 may, optionally, generate electromagnetic fields 212, as shown in FIG. 2A, to guide and position the metal caps 204 of the carbon nanotube 200 in contact with the electrodes 210. Other techniques such as self-assembly monolayer patterns or chemical functional groups may also be used for the similar purpose. In one embodiment, as the carbon nanotube 200 includes the metal caps 204, the carbon nanotube 200 may be electrically coupled with the electrodes 210, for example, by an annealing process or electron-gun irradiation. However, it should be appreciated that any other suitable methods may be employed for the coupling without departing from the scope of the claimed subject matter.

In one embodiment, FIG. 2B illustrates a nano-structure 232 having a nanotube 200 having metal caps 204. The nanotube 200 is coupled with electrode S and electrode D. For example, the nanotube 200 is positioned with electrode S and electrode D, where metal caps 204 are in contact with electrode S and electrode D.

The nano-structure of FIG. 2B further illustrates a back gate 224 and substrate 222, where the substrate 222 abuts the back gate 224. In one embodiment, the substrate 222 may include, but not limited to, for example, silicon dioxide (SiO₂). In other embodiments, the substrate 222 may include other substrates such as semiconductor substrates (e.g., silicon substrate, III-V group semiconductor substrate, etc.), electro-conductive substrates (e.g., metal substrate, electro-conductive organic compound substrate, etc.), non-electro-conductive substrates (e.g., glass substrate, macromolecule compound substrate, etc.), silicon-on-insulator (SOI) substrates and the like. The back gate 224 may include, but not limited to, for example, silicon (Si). However, it should be appreciated that the substrate 222 and the back gate 224 are certainly not limited to the above.

The electrode S and electrode D of FIG. 2B are positioned to abut the substrate, where the electrodes S and D are positioned having a predetermined distance between them. Further, as shown in FIG. 2B, the electrodes S and D 220 may be a source electrode and a drain electrode, where the source electrode S is connected in series to a galvanometer 226, a voltage source 228 and the drain electrode D. Another voltage source 230 is connected between the back gate 224 and the wire between the voltage source 228 and the drain electrode D so that the voltage source 230 may control the back gate 224.

In one embodiment, the nano-structure 232 is a carbon nanotube field-effect transistor (NTFET) serving as a bio/chemical sensor. In the bio/chemical sensor 232, the carbon nanotube 200 may provide the advantages of biocompatibility, size compatibility and sensitivity towards minute electrical perturbations. Changes in the conductivity of the carbon nanotube 200 may be used to detect the biomolecules which interact with the carbon nanotube 200. Some exemplary applications of the bio/chemical sensor 232 may include, but not limited to, detection of proteins, antibody-antigen assays, DNA hybridization, enzymatic reactions involving carbohydrates, etc. It is noted that the detailed structure of the bio/chemical sensor 232 as above is provided only for illustrative purposes and may be modified by one of ordinary skill in the art without departing from the scope of the claimed subject matter.

Another example of a nano-structure, which can be fabricated with a carbon nanotube 200, is described with reference to FIG. 2C. In FIG. 2C, the carbon nanotube 200 includes a carbon nanotube body 202, metal caps 204 and one or more nanoparticles 206. In this embodiment, the carbon nanotube 200 may be assembled onto electrodes 240 to result in a memory device 242 (the status of its carbon nanotube 200 may be changed as desired and can be read out). The memory device 200 may have various applications including, but not limited to, electronic devices such as computers, home appliances, etc. The electrodes 240 as shown in FIG. 2C may be further coupled with other elements, as can be appreciated by one of ordinary skill in the art. In one embodiment, the memory device 242 may be configured to move the nanoparticles 206 from one side of the carbon nanotube 200 to the other side thereof in response to a stimulus such as an electrical signal, an electromagnetic energy, or photon energy. The nanoparticles 206 may remain in position unless another stimulus is applied to the carbon nanotube 200. Thus, it should be appreciated that this type of operation may correspond to storage of data.

In order to read the stored data, the memory device 242 may be configured to detect the current position of the nanoparticles 206 in several methods. For instance, the nanoparticles 206 may be electrified in advance and the electrical imbalance between the two sides of the carbon nanotube 200 may be detected so as to determine the position of the nanoparticles 206. However, it should be recognized herein that any other suitable methods capable of detecting the position of the nanoparticles 206 may be used instead. Further, it should be appreciated that the structure of the memory device 242, as shown in FIG. 2C, is provided only for illustrative purposes and is not intended to limit the structure of the memory device 242 or the scope of the claimed subject matter. That is, the memory device 242 may have other suitable structures without departing from the scope of the claimed subject matter.

Some examples of the devices, which can be fabricated with the carbon nanotube having metal caps, have been illustrated above. However, it should be noted that the applicable devices are not limited to the bio/chemical sensors or the memory devices as described above. The carbon nanotube with metal caps in accordance with the present disclosure may be applied to various other devices via the same manner described above or via other suitable manners that can be conceived by those skilled in the art without departing from the scope of the claimed subject matter. Some examples of such devices include, but not limited to, a gas alarm, a hygrometer, a pH meter, a pressure gauge, a tactile sensor and the like.

Furthermore, it should be appreciated that the carbon nanotube having metal caps may be useful in many other applications. That is, the embodiments in the present disclosure should not exclude any other potential applications of a carbon nanotube having metal caps from the scope of the claimed subject matter.

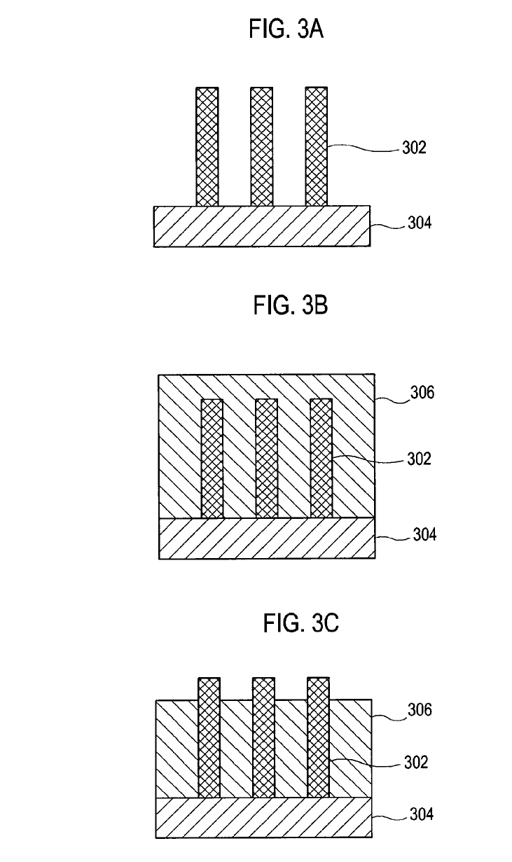

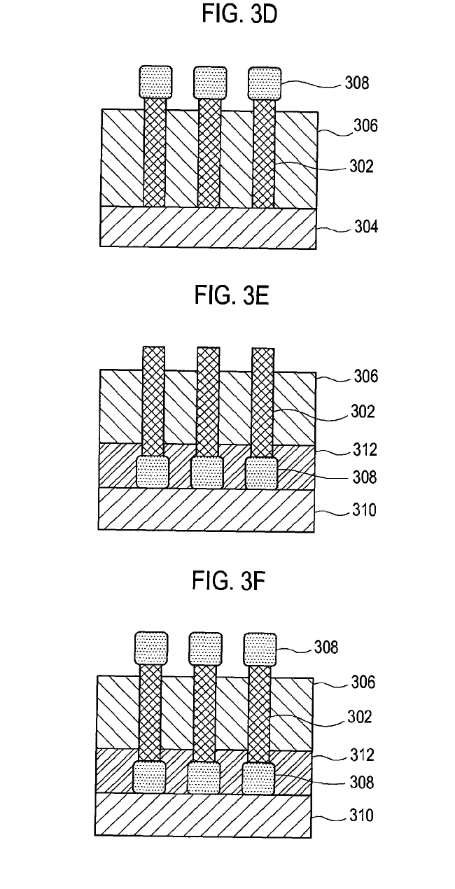

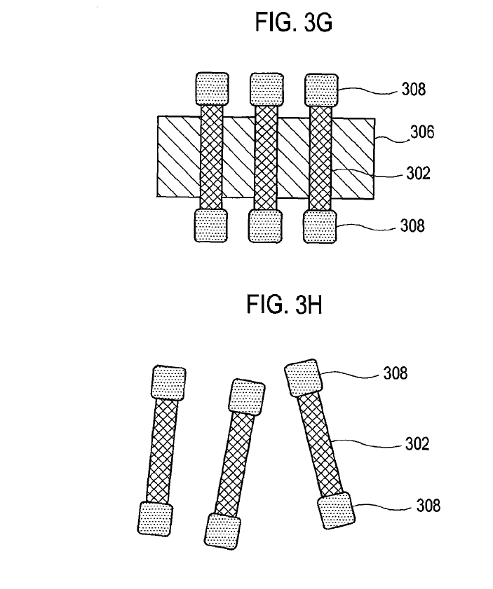

Hereinafter, with reference to FIGS. 3A to 3H, one embodiment of a method of manufacturing carbon nanotubes 300 is illustrated. For example, the illustrative embodiment as shown in FIGS. 3A to 3H provides the method of manufacturing carbon nanotubes 300 having a carbon nanotube body and one or more metal caps.

FIG. 3A shows a substrate 304 suitable for growing nano-structures. For example, the substrate 304 is subjected to some predetermined conditions where nano-structures such as carbon nanotubes 302 are grown on the substrate 304. The carbon nanotubes can be grown where a plurality of carbon nanotubes are grown in a predetermined direction, aligned to each other. The grown carbon nanotubes can be the carbon nanotube bodies. In one embodiment, one or more nanoparticles may be incorporated into the carbon nanotube bodies 302, although not shown in FIG. 3A.

As shown in FIG. 3B, the carbon nanotube bodies 302 are insulated with an insulating material 306. The insulation may be performed by, for example, spin-coating of spin-on-glass, deposition of tetraethoxysilane oxide or any other generally available insulation methods. The lengths of the carbon nanotube bodies 302 may be adjusted by performing a CMP (chemical mechanical polishing) process; and in one embodiment, the lengths can be adjusted to a predetermined nano-length. One plane of the insulating material 306 is removed to expose terminals of the grown carbon nanotube bodies 302, as shown in FIG. 3C. The removal of the insulating material 306 may be accomplished with, for example, hydrofluoric acids, although any appropriate method may be used.

Further, as shown in FIG. 3D, metal caps 308 can be fabricated on the exposed terminals of the carbon nanotube bodies 302. The fabrication may be performed by using several methods. Examples of the methods include an electro/electroless plating and chemical self-assembly with nanoparticles. However, it should be appreciated that any other suitable methods can be employed to fabricate the metal caps 308 on the exposed terminals of the carbon nanotube bodies 302 without departing from the scope of the claimed subject matter.

As illustrated in FIG. 3D, the carbon nanotubes bodies 302 that are grown on the substrate 304 include metal caps 308 on one end of the bodies. In one embodiment, the carbon nanotube bodies 302 having the metal caps 308 may be separated from the substrate 304 resulting in carbon nanotubes with one metal cap on one end of the body.

The methods of separating the carbon nanotube bodies 302 from the substrate can be performed by, for example, mechanically detaching the substrate 304 from the carbon nanotube bodies 302 or chemically etching the substrate 304 away from the carbon nanotube bodies 302. By doing so, the carbon nanotubes having one metal cap at one terminal thereof, can be fabricated in a parallel manner. When the insulating material 306 is removed the individual carbon nanotube having one metal cap will become available.

However, carbon nanotubes each having two or more metal caps can be also fabricated in accordance with one embodiment. FIG. 3E illustrates one example where the carbon nanotubes 300 each having one metal cap 308 may be settled or positioned on another substrate 310 such that the metal caps 308 are placed closer to the substrate 310 than second terminals of the carbon nanotube bodies 302 without the metal caps 308. In one embodiment, the metal caps 308 may be attached to the substrate 310 by a conductive paste 312 in order to place the carbon nanotube bodies 302 on the substrate 310. For example, a silver paste or the like may be used as the conductive paste 312. It should be noted that the positioning of the carbon nanotube bodies 302 on the substrate 310 may be performed before removing the insulating material 306, and even before separating the carbon nanotube bodies 302 from the substrate 304. In the latter case, however, it is preferred that the separation of the substrate 304 does not induce the separation of the substrate 310 from the carbon nanotube bodies 302.

The metal caps 308 may be fabricated on the second terminals of the carbon nanotube bodies 302, as shown in FIG. 3F. In one embodiment, the fabrication may be performed in a similar manner as shown in FIGS. 3C and 3D. In this case, the upper side (i.e., the side relatively far from the substrate 310) of the insulating material 306 is removed to expose the second terminals (which do not have the metal caps 308) of the carbon nanotube bodies 302. Thereafter, the metal caps 308 may be fabricated on the exposed second terminals of the carbon nanotube bodies 302.

After the fabrication of the metal caps 308 on the second terminals, the substrate 310 may be separated from the carbon nanotube bodies 302, as shown in FIG. 3G. Further, as shown in FIG. 3H, the insulating material 306 may be removed from the carbon nanotube bodies 302. In one embodiment, the substrate 310 may be separated from the carbon nanotube bodies 302 by removing the conductive paste 312. Specifically, when the conductive paste 312 is a silver paste, the conductive paste 312 can be easily etched by, for example, an acetone solution. By doing so, carbon nanotubes each including two metal caps in accordance with one embodiment can be fabricated. Moreover, although not described herein in detail, carbon nanotubes with more than two metal caps may also be easily manufactured in a similar manner by one of ordinary skill in the art. For example, one of such carbon nanotubes may be a comb-shaped carbon nanotube, wherein each of its teeth has a cap thereon.

The methods as described above may be viewed as a type of parallel manipulation and thus may enhance the speed limitation posed by conventional serial methods. Further, according to the assembly method, the alignment and placement can be precisely controlled since carbon nanotubes with metal caps are more effectively influenced by electromagnetic fields. Moreover, welding of carbon nanotubes with electrodes can be easily achieved by a simple annealing process or an electron-gun irradiation.

Although embodiments of methods of manufacturing carbon nanotubes 300 have been described above, it should be recognized herein that this is not the only manufacturing method. That is, any modification or variation can be made by one of ordinary skill in the art without departing from the scope of the claimed subject matter. For example, in some embodiments, the metal caps 308 may be fabricated by the same operation on both terminals of the carbon nanotube bodies 302. In this case, as shown in FIG. 3B, the substrate 304 may be separated from the carbon nanotube bodies 302. Thereafter, the upper and lower sides of the insulating material 306 are removed to expose both of the terminals of the carbon nanotube bodies 302, after which the metal caps 308 may be simultaneously fabricated on both terminals of the carbon nanotube bodies 302.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used herein is for the purpose of describing particular embodiments only, and is not intended to be limiting.

For this and other processes and methods disclosed herein, one skilled in the art can appreciate that the functions performed in the processes and methods may be implemented in different orders, sequentially, concurrently, and/or repetitively. Further, the outlined steps and operations are only provided as examples. That is, some of the steps and operations may be optional, combined into fewer steps and operations, or expanded into additional steps and operations without detracting from the essence of the disclosed embodiments.

In light of the present disclosure, those skilled in the art will appreciate that the apparatus and methods described herein may be implemented in hardware, software, firmware, middleware or combinations thereof and utilized in systems, subsystems, components or sub-components thereof. For example, a method implemented in software may include computer code to perform the operations of the method. This computer code may be stored in a machine-readable medium, such as a processor-readable medium or a computer program product, or transmitted as a computer data signal embodied in a carrier wave, or a signal modulated by a carrier, over a transmission medium or communication link. The machine-readable medium or processor-readable medium may include any medium capable of storing or transferring information in a form readable and executable by a machine (e.g., by a processor, a computer, etc.).

The present disclosure may be embodied in other specific forms without departing from its basic features or characteristics. Thus, the described embodiments are to be considered in all respects only as illustrative and not restrictive. The scope of the disclosure is, therefore, indicated by the appended claims, rather than by the foregoing description. All changes within the meaning and range of equivalency of the claims are to be embraced within their scope.

What is claimed is:

1. A nano-structure, comprising:
a nanotube having a first end and a second end; and
a first nano-cap,
wherein the first nano-cap is positioned at the first end of the nanotube.

2. The nano-structure of claim 1, wherein the nanotube comprises a carbon nanotube.

3. The nano-structure of claim 1, further comprising a second nano-cap, wherein the second nano-cap is positioned at the second end of the nanotube.

4. The nano-structure of claim 1, wherein the first nano-cap includes a metal.

5. The nano-structure of claim 4, wherein the metal includes any one of noble metals and magnetic metals.

6. The nano-structure of claim 1, further comprising at least one nanoparticle, wherein the at least one nanoparticle is positioned within the nanotube.

7. The nano-structure of claim 6, wherein the at least one nanoparticle includes any one of C60 nanoparticles and metal nanoparticles.

8. A method of coupling a nanotube and an electrode, comprising the steps of:
positioning the nanotube with an electrode, wherein the nanotube includes at least one metal cap; and
coupling the at least one metal cap with the electrode.

9. The method of claim 8, wherein coupling includes welding the at least one metal cap to the electrode.

10. The method of claim 9, wherein welding includes performing an annealing process.

11. The method of claim 9, wherein welding includes performing an electron-gun irradiation.

12. The method of claim 8, wherein positioning includes applying an electromagnetic force to the carbon nanotube.

13. An apparatus, comprising:
a first electrode; and
a nanotube having a first cap,
wherein the first cap is coupled with the first electrode.

14. The apparatus of claim 13, wherein the apparatus is any one of a bio/chemical sensor and a memory device.

15. The apparatus of claim 13, further comprising a second electrode, wherein the nanotube further has a second cap coupled with the second electrode.

16. A method of creating a nano-structure, comprising the steps of:
growing a nanotube on a substrate;
insulating the nanotube with an insulating material;
removing a first side of the insulating material exposing a first portion of the nanotube;
adding a cap on the first portion of the nanotube; and
removing the substrate from the nanotube.

17. The method of claim 16, wherein growing includes inserting nanoparticles into the nanotube.

18. The method of claim 16, wherein insulating includes performing a spin-coating of spin-on-glass.

19. The method of claim 16, wherein insulating includes performing a deposition of tetraethoxysilane oxide.

20. The method of claim 16, further comprising adjusting length of the nanotube.

21. The method of claim 20, wherein adjusting includes performing a CMP process.

22. The method of claim 16, wherein removing the first side of the insulating material includes removing the first side of the insulating material by hydrofluoric acids.

23. The method of claim 16, wherein adding includes adding the cap by an electro/electroless plating.

24. The method of claim 16, wherein adding includes adding the cap by a chemical self-assembly with nanoparticles.

25. The method of claim 16, wherein removing the substrate from the nanotube includes physically detaching the substrate from the nanotube.

26. The method of claim 16, wherein removing the substrate from the nanotube includes chemically etching the substrate away.

27. The method of claim 16, further comprising:
positioning the nanotube with the metal cap on a second substrate such that the metal cap is placed closer to the second substrate than a second portion of the nanotube;
removing a second side of the insulating material exposing the second portion of the nanotube;
adding a second cap on the second portion of the nanotube;
removing the second substrate from the nanotube; and
removing the insulating material from the nanotube.

28. The method of claim 27, wherein positioning includes attaching the cap on the first portion of the nanotube to the second substrate by a conductive paste.

29. The method of claim 28, wherein the conductive paste is a silver paste.

30. The method of claim 28, wherein removing the second substrate from the nanotube includes removing the conductive paste.

31. The method of claim 30, wherein removing the conductive paste includes etching the conductive paste with an acetone solution.
